(19) United States
(12) Patent Application Publication
(10) Pub. No.: US 2008/0154811 A1
(43) Pub. Date: Jun. 26, 2008

(54) Method and system for verifying virtual sensors

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/642,913

(22) Filed: Dec. 21, 2006

(51) Int. Cl. G06N 3/12; G06F 17/10; G06F 15/18

(52) U.S. Cl. 706/13; 703/2; 706/16

(57) ABSTRACT

A method is provided for a virtual sensor system. The method may include starting at least one established virtual sensor process model indicative of interrelationships between a plurality of input parameters and a plurality of output parameters and retrieving calibration data associated with the virtual sensor process model. The method may also include obtaining a set of values of the plurality of input parameters and calculating corresponding values of the plurality of output parameters simultaneously based upon the set of values of the plurality of input parameters and the virtual sensor process model. Further, the method may include determining whether the set of values of input parameters are qualified for the virtual sensor process model to generate the values of the plurality of output parameters with desired accuracy based on the calibration data.

### TECHNICAL FIELD

This disclosure relates generally to virtual sensor techniques and, more particularly, to verifying operation of process model based virtual sensor systems.

### BACKGROUND

Physical sensors, such as nitrogen oxides (NOₓ) sensors, are widely used in many products, such as modern vehicles, to measure and monitor various parameters associated with motor vehicles. Physical sensors often take direct measurements of the physical phenomena and convert these measurements into measurement data to be further processed by control systems. Although physical sensors take direct measurements of the physical phenomena, physical sensors and associated hardware are often costly and, sometimes, unreliable. Further, when control systems rely on physical sensors to operate properly, a failure of a physical sensor may render such control systems inoperable.

Instead of direct measurements, virtual sensors are developed to process various physically measured values and to produce values that are previously measured directly by physical sensors. For example, U.S. Pat. No. 5,386,373 (the '373 patent) issued to Keeler et al. on Jan. 31, 1995, discloses a virtual continuous emission monitoring system with sensor validation. The '373 patent uses a back propagation-to-activation model and a monte-carlo search technique to establish and optimize a computational model used for the virtual sensing system to derive sensing parameters from other measured parameters. However, such conventional techniques often fail to address inter-correlation between individual measured parameters, especially at the time of generation and/or optimization of computational models, or to correlate the other measured parameters to the sensing parameters.

Further, the conventional techniques often fail to understand or verify the accuracy of virtual sensors during operation, particularly, when the virtual sensors encounter unfamiliar data patterns. Also, because there often are no mechanical rules in determining the accuracy of outputs of virtual sensors, conventional techniques may fail to implement practical real-time evaluation or verification of the virtual sensor operation.

Methods and systems consistent with certain features of the disclosed systems are directed to solving one or more of the problems set forth above.

### SUMMARY OF THE INVENTION

One aspect of the present disclosure includes a method for a virtual sensor system. The method may include starting at least one established virtual sensor process model indicative of interrelationships between a plurality of input parameters and a plurality of output parameters and retrieving calibration data associated with the virtual sensor process model. The method may also include obtaining a set of values of the plurality of input parameters and calculating corresponding values of the plurality of output parameters simultaneously based upon the set of values of the plurality of input parameters and the virtual sensor process model. Further, the method may include determining whether the set of values of input parameters are qualified for the virtual sensor process model to generate the values of the plurality of output parameters with desired accuracy based on the calibration data.

Another aspect of the present disclosure includes a system for a virtual sensor process model. The system may include a database and a processor. The database may be configured to store information relevant to the virtual sensor process model and calibration data associated with the virtual sensor process model. The processor may be configured to start the virtual sensor process model indicative of interrelationships between a plurality of input parameters and a plurality of output parameters and to retrieve calibration data associated with the virtual sensor process model. The processor may also be configured to obtain a set of values of the plurality of input parameters and to calculate corresponding values of the plurality of output parameters simultaneously based upon the set of values of the plurality of input parameters and the virtual sensor process model. Further, the processor may be configured to determine whether the set of values of input parameters are qualified for the virtual sensor process model to generate the values of the plurality of output parameters with desired accuracy based on the calibration data.

Another aspect of the present disclosure includes a computer-readable medium for use on a computer system configured to establish at least one virtual sensor process model, the computer-readable medium having computer-executable instructions for performing a method. The method may include obtaining data records associated with one or more input variables and a plurality of output parameters and selecting the plurality of input parameters from the one or more input variables. The method may also include generating a computational model indicative of the interrelationships between the plurality of input parameters and the plurality of output parameters and determining desired statistical distributions of the plurality of input parameters of the computational model. Further, the method may include defining a desired input space based on the desired statistical distributions and storing data used and created during the establishment of the process model as the calibration data associated with the process model.

### BRIEF DESCRIPTION OF THE DRAWINGS

FIG. 1 shows an exemplary vehicle incorporating certain features consistent with certain disclosed embodiments;

FIG. 2 shows a block diagram of an exemplary engine control module consistent with certain disclosed embodiments;

FIG. 3 illustrates a block diagram of an exemplary virtual sensor system consistent with certain disclosed embodiments;

FIG. 4 shows a flowchart of an exemplary model generation and optimization process consistent with certain disclosed embodiments; and

FIG. 5 shows a flow chart of an exemplary operation process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

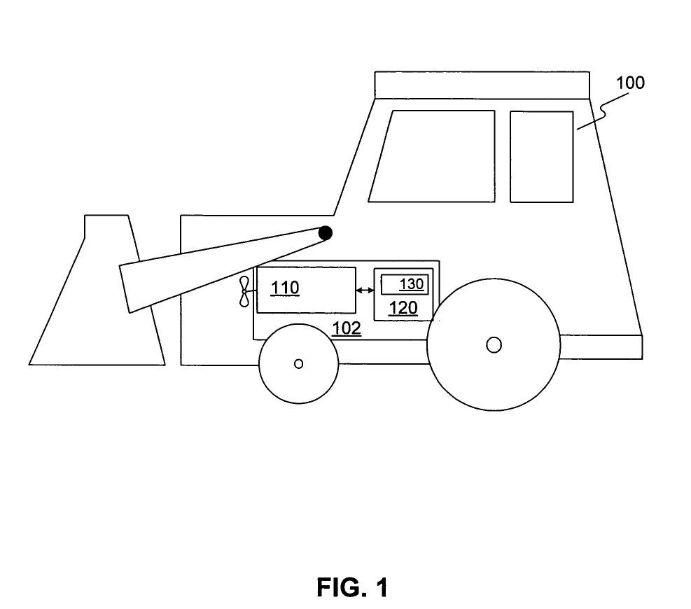

FIG. 1 illustrates an exemplary vehicle 100 in which features and principles consistent with certain disclosed embodiments may be incorporated. Vehicle 100 may include any type of fixed or mobile machine that performs some type of operation associated with a particular industry, such as mining, construction, farming, transportation, etc. and operates between or within work environments (e.g., construction site, mine site, power plants and generators, on-highway applications, etc.). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. Vehicle 100 may also include any type of commercial vehicles such as cars, vans, and other vehicles.

As shown in FIG. 1, vehicle 100 may include an engine system 102. Engine system 102 may include an engine 110 and an engine control module (ECM) 120. Further, ECM 120 may include a virtual sensor system 130. It is understood that the devices are listed for illustrative purposes and that other devices or components may also be included. For example, engine system 102 may also include various physical sensors (not shown) provided for measuring certain parameters of vehicle operating environment or engine parameters, such as emission sensors for measuring emissions of vehicle 100, such as nitrogen oxides (NOₓ), sulfur dioxide (SO₂), carbon monoxide (CO), total reduced sulfur (TRS), etc.

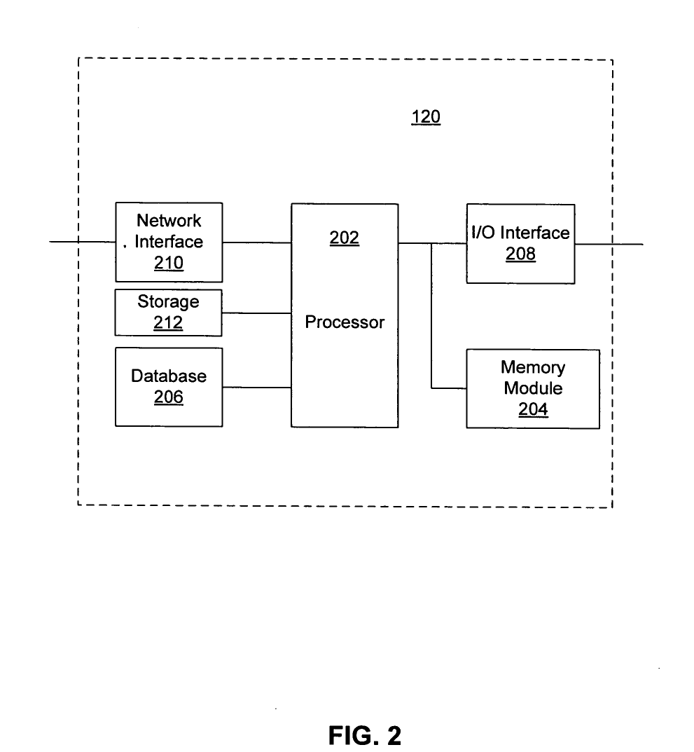

Engine 110 may include any appropriate type of engine or power source that generates power for vehicle 100, such as an internal combustion engine or an electric-gas hybrid engine, etc. ECM 120 may include any appropriate type of engine control system configured to perform engine control functions such that engine 110 may operate properly. Further, ECM 120 may also control other systems of vehicle 100, such as transmission systems, and/or hydraulics systems, etc. FIG. 2 shows an exemplary functional block diagram of ECM 120.

As shown in FIG. 2, ECM 120 may include a processor 202, a memory module 204, a database 206, an I/O interface 208, a network interface 210, and a storage 212. Other components or devices, however, may also be included in ECM 120. Further, the listed devices and other devices may be implemented in hardware, such as field programmable gate array (FPGA) devices, etc., computer software, or a combination of hardware and software. Certain FPGA devices may be reconfigured to selectively support functions provided by the listed devices.

Processor 202 may include any appropriate type of general purpose microprocessor, digital signal processor, or microcontroller. Memory module 204 may include one or more memory devices including, but not limited to, a ROM, a flash memory, a dynamic RAM, and/or a static RAM. Memory module 204 may be configured to store information used by processor 202. More than one memory module may be included.

Database 206 may include any type of appropriate database containing information on engine parameters, operation conditions, mathematical models, and/or any other control information. Further, I/O interface 208 may include any appropriate type of device or devices provided to couple processor 202 to various physical sensors or other components (not shown) within engine system 102 or within vehicle 100.

Information may be exchanged between external devices or components, such as engine 110 or the various physical sensors, etc., and processor 202. A user or users of vehicle 100 may also exchange information with processor 202 through I/O interface 208. The users may input data to processor 202, and processor 202 may output data to the users, such as warning or status messages. Further, I/O interface 208 may also be used to obtain data from other components (e.g., the physical sensors, etc.) and/or to transmit data to these components from ECM 120.

Network interface 210 may include any appropriate type of network device capable of communicating with other computer systems based on one or more communication protocols. Network interface 210 may communicate with other computer systems within vehicle 100 or outside vehicle 100 via certain communication media such as control area network (CAN), local area network (LAN), and/or wireless communication networks.

Storage 212 may include any appropriate type of mass storage provided to store any type of information that processor 202 may need to operate. For example, storage 212 may include one or more floppy disk devices, hard disk devices, optical disk devices, or other storage devices to provide storage space.

Returning to FIG. 1, ECM 120 may include virtual sensor system 130 for providing various parameters used in engine control functions. Virtual sensor system 130 may include any appropriate type of control system that generate values of sensing parameters based on a computational model and a plurality of measured parameters.

As used herein, the sensing parameters may refer to those measurement parameters that are directly measured by a particular physical sensor. For example, a physical NOₓ emission sensor may measure the NOₓ emission level of vehicle 100 and provide values of NOₓ emission level, the sensing parameter, to ECM 120. Virtual sensor system 130 may include a virtual sensor to predict or derive a sensing parameter such that a corresponding physical sensor may be omitted. Virtual sensor system 130 may determine most likely NOₓ emission levels and may provide these levels to ECM 120. In certain embodiments, virtual sensor system 130 may include a plurality of virtual sensors based on process models. For example, virtual sensor system 130 may include a virtual NOₓ emission sensor to replace or supplement the physical NOₓ emission sensor to predict the sensing parameter of NOₓ emission level.

Sensing parameters may also include any output parameters that may be measured indirectly by physical sensors and/or calculated based on readings of physical sensors. For example, a virtual sensor may provide an intermediate sensing parameter that may be unavailable from any physical sensor. In general, sensing parameters may be included in outputs of a virtual sensor.

On the other hand, the measured parameters, as used herein, may refer to any parameters relevant to the sensing parameters and indicative of the state of a component or components of vehicle 100, such as engine 110. For example, for the sensing parameter NOₓ emission level, measured parameters may include machine and environmental parameters, such as compression ratios, turbocharger efficiency, aftercooler characteristics, temperature values, pressure values, ambient conditions, fuel rates, and engine speeds, etc. Measured parameters may often be included in inputs to be provided to a virtual sensor. Measured parameters may also be provided by one virtual sensor model to a second virtual sensor model, such that a network of virtual sensors may be created with interrelated virtual sensors.

Although virtual sensor system 130, as shown in FIG. 1, is configured to coincide with ECM 120, virtual sensor system 130 may also be configured as a separate control system or as a part of other control systems within vehicle 100. Further, ECM 120 may implement virtual sensor system 130 by using computer software, hardware, or a combination of software and hardware. For example, ECM 120 may execute software programs to generate the values of sensing parameters (e.g., NOₓ emission level) based on a computational model and other parameters.

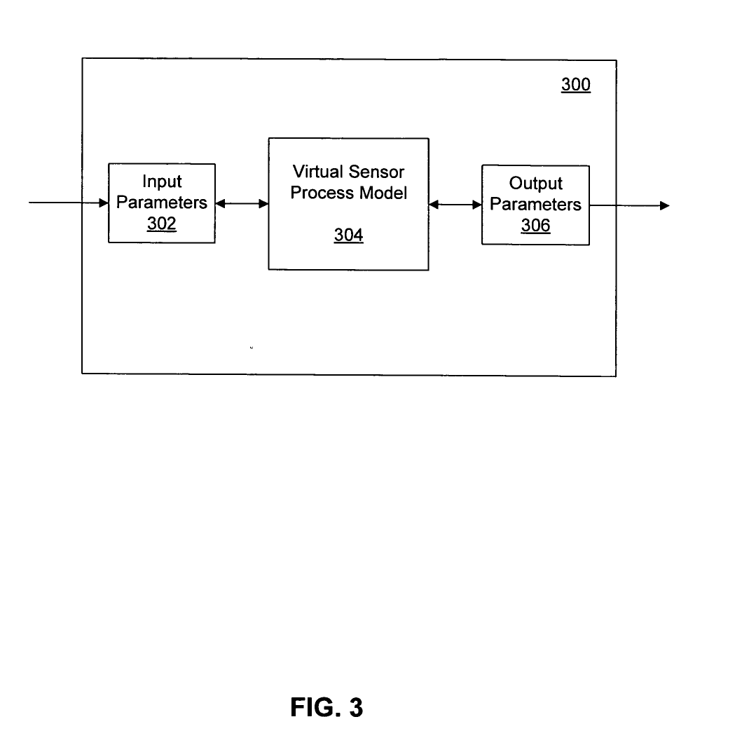

In operation, computer software instructions may be stored in or loaded to ECM 120. ECM 120 may execute the computer software instructions to perform various control functions and processes to control engine 110 and to automatically adjust engine operational parameters, such as fuel injection timing and fuel injection pressure, etc. In particular, ECM 120 may execute computer software instructions to generate and/or operate virtual sensor system 130 and virtual sensors included in virtual sensor system 130 to provide engine emission values and other parameter values used to control engine 110. FIG. 3 shows a logical block diagram of an exemplary virtual sensor 300 included in virtual sensor system 130.

As shown in FIG. 3, virtual sensor 300 may include a virtual sensor process model 304, input parameters 302, and output parameters 306. Virtual sensor process model 304 may be established to build interrelationships between input parameters 302 (e.g., measured parameters) and output parameters 306 (e.g., sensing parameters). After virtual sensor process model 304 is established, values of input parameters 302 may be provided to virtual sensor process model 304 to generate values of output parameters 306 based on the given values of input parameters 302 and the interrelationships between input parameters 302 and output parameters 306 established by virtual sensor process model 304.

In certain embodiments, virtual sensor 300 may be configured to include a virtual emission sensor to provide levels of substance emitted from an exhaust system (not shown) of engine 110, such as levels of nitrogen oxides (NOₓ), sulfur dioxide (SO₂), carbon monoxide (CO), total reduced sulfur (TRS), soot (i.e., a dark powdery deposit of unburned fuel residues in emission), and/or hydrocarbon (HC), etc. In particular, NOₓ emission level, soot emission level, and HC emission level may be important to normal operation of engine 110 and/or to meet certain environmental requirements. NOₓ emission level, soot emission level, and HC emission level may be referred to as regulated emission levels. Other emission levels, however, may also be included. For example, these emission levels may also include levels of side effects of operating a machine, such as sound emission levels, heat rejection levels, and vibration levels, etc.

Input parameters 302 may include any appropriate type of data associated with or related to the regulated emission levels. For example, input parameters 302 may include parameters that control operations of various characteristics of engine 110 and/or parameters that are associated with conditions corresponding to the operations of engine 110. Input parameters 302 may include engine speed, fuel rate, injection timing, intake manifold temperature (IMAT), intake manifold pressure (IMAP), inlet valve actuation (IVA) end of current, IVA timing, injection pressure, etc. Further, input parameters 302 may be measured by certain physical sensors, such as a high precision lab grade physical sensor, or created by other control systems. Other parameters, however, may also be included. For example, input parameters 302 may also include some or all of total fuel injection quantity, oxygen/fuel molar ratio, atmospheric pressure, total induction mass flow, etc.

On the other hand, output parameters 306 may correspond to sensing parameters. For example, output parameters 306 of virtual sensor 300 may include an emission level of NOₓ, a soot emission level, or an HC emission level, etc. Other types of output parameters, however, may also be used by virtual sensor 300. Output parameters 306 (e.g., NOₓ emission level, soot emission level, or HC emission level) may be used by ECM 120 to predict regulated emission levels and to control engine 110.

Virtual sensor process model 304 may include any appropriate type of mathematical or physical model indicating interrelationships between input parameters 302 and output parameters 306. For example, virtual sensor process model 304 may be a neural network based mathematical model that is trained to capture interrelationships between input parameters 302 and output parameters 306. Other types of mathematic models, such as fuzzy logic models, support vector machines, linear system models, and/or non-linear system models, etc., may also be used.

Virtual sensor process model 304 may be trained and validated using data records collected from a particular engine application for which virtual sensor process model 304 is established. That is, virtual sensor process model 304 may be established and/or operated according to particular rules corresponding to a particular type of model using the data records, and the interrelationships of virtual sensor process model 304 may be verified by using part of the data records.

After virtual sensor process model 304 is trained and validated, virtual sensor process model 304 may be optimized to define a desired input space of input parameters 302 and/or a desired distribution of output parameters 306. The validated or optimized virtual sensor process model 304 may be used to produce corresponding values of output parameters 306 when provided with a set of values of input parameters 302.

The establishment and operations of virtual sensor process model 304 may be carried out by processor 202 based on computer programs stored on or loaded to virtual sensor 300. Alternatively, the establishment of virtual sensor process model 304 may be realized by other computer systems, such as a separate computer system (not shown) configured to create process models. The created process model may then be loaded to virtual sensor 300 (e.g., ECM 120 containing block 130) for operations.

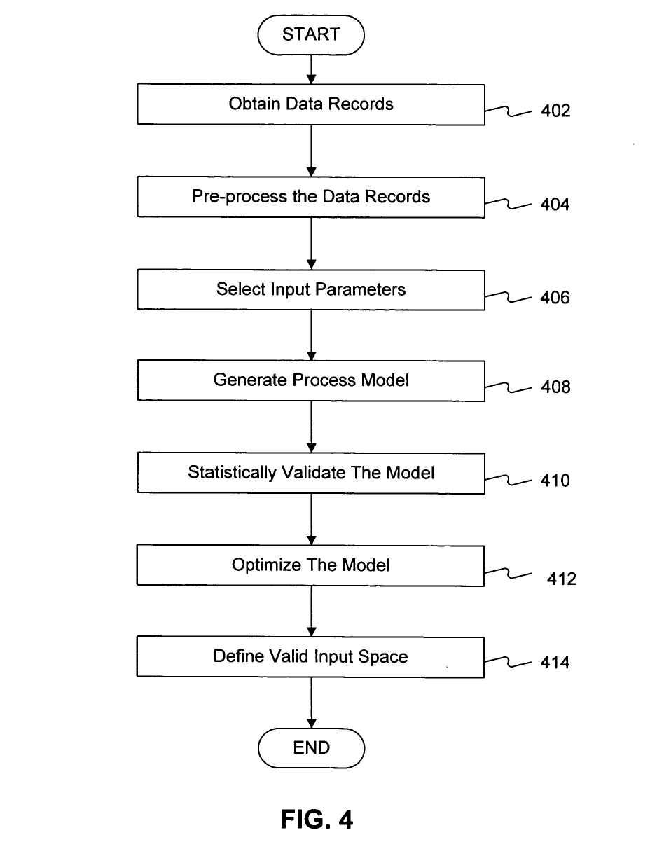

Processor 202 may perform a virtual sensor process model generation and optimization process to generate and optimize virtual sensor process model 304. FIG. 4 shows an exemplary model generation and optimization process performed by processor 202. As shown in FIG. 4, at the beginning of the model generation and optimization process, processor 202 may obtain data records associated with input parameters 302 and output parameters 306 (step 402).

The data records may include information characterizing engine operations and emission levels including NOₓ emission levels. Physical sensors, such as physical NOₓ emission sensors, may be provided to generate data records of output parameters 306 (e.g., sensing parameters such as NOₓ levels). ECM 120 and/or physical sensors may provide data records of input parameters 302 (e.g., measured parameters, such as intake manifold temperature, intake manifold pressure, ambient humidity, fuel rates, and engine speeds, etc.). Further, the data records may include both input parameters and output parameters and may be collected based on various engines or based on a single test engine, under various predetermined operational conditions.

The data records may also be collected from experiments designed for collecting such data. Alternatively, the data records may be generated artificially by other related processes, such as other emission modeling or analysis processes. The data records may also include training data used to build virtual sensor process model 304 and testing data used to validate virtual sensor process model 304. In addition, the data records may also include simulation data used to observe and optimize virtual sensor process model 304.

The data records may reflect characteristics of input parameters 302 and output parameters 306, such as statistic distributions, normal ranges, and/or precision tolerances, etc. After obtaining the data records (step 402), processor 202 may pre-process the data records to clean up the data records for obvious errors and to eliminate redundancies (step 404). Processor 202 may remove approximately identical data records and/or remove data records that are out of a reasonable range in order to be meaningful for model generation and optimization. After the data records have been pre-processed, processor 202 may select proper input parameters by analyzing the data records (step 406).

The data records may be associated with many input variables, such as variables corresponding to fuel rate, injection timing, intake manifold pressure, intake manifold temperature, IVA end of current, injection pressure, and engine speed, etc. and other variables that are not corresponding to above listed parameters, such as torque, acceleration, etc. The number of input variables may be greater than the number of a particular set of input parameters 102 used for virtual sensor process model 304. That is, input parameters 102 may be a subset of the input variables, and only selected input variables may be included in input parameters 302. For example, input parameter 302 may include fuel rate, injection timing, intake manifold pressure, intake manifold temperature, IVA end of current, injection pressure, and engine speed, etc., of the input variables.

A large number of input variables may significantly increase computational time during generation and operations of the mathematical models. The number of the input variables may need to be reduced to create mathematical models within practical computational time limits. That is, input parameters 302 may be selected from the input variables such that virtual sensor process model 304 may be operated with a desired speed or efficiency. Additionally, in certain situations, the number of input variables in the data records may exceed the number of the data records and lead to sparse data scenarios. Some of the extra input variables may have to be omitted in certain mathematical models such that practical mathematical models may be created based on reduced variable number.

Processor 202 may select input parameters 302 from the input variables according to predetermined criteria. For example, processor 202 may choose input parameters 302 by experimentation and/or expert opinions. Alternatively, in certain embodiments, processor 202 may select input parameters based on a mahalanobis distance between a normal data set and an abnormal data set of the data records. The normal data set and abnormal data set may be defined by processor 202 using any appropriate method. For example, the normal data set may include characteristic data associated with input parameters 302 that produce desired values of output parameters 306. On the other hand, the abnormal data set may include any characteristic data that may be out of tolerance or may need to be avoided. The normal data set and abnormal data set may be predefined by processor 202.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as

MDᵢ=(Xᵢ−μₓ)Σ⁻¹(Xᵢ−μₓ)′ (1)

where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Processor 202 may select input parameter 302 as a desired subset of input variables such that the mahalanobis distance between the normal data set and the abnormal data set is maximized or optimized. A genetic algorithm may be used by processor 202 to search input variables for the desired subset with the purpose of maximizing the mahalanobis distance. Processor 202 may select a candidate subset of the input variables based on a predetermined criteria and calculate a mahalanobis distance MDₙₒᵣₘₐₗ of the normal data set and a mahalanobis distance MD_{abnormal} of the abnormal data set. Processor 202 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Processor 202 may select the candidate subset of input variables if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of input variables may be created for further searching. This searching process may continue until the genetic algorithm converges and a desired subset of input variables (e.g., input parameters 302) is selected.

Optionally, mahalanobis distance may also be used to reduce the number of data records by choosing a part of data records that achieve a desired mahalanobis distance, as explained above. Further, mahalanobis distance for each data record may also be stored along with the data record for further analysis or to be used later.

After selecting input parameters 302 (e.g., fuel rate, injection timing, intake manifold pressure, intake manifold temperature, IVA end of current, injection pressure, and engine speed, etc.), processor 202 may generate virtual sensor process model 304 to build interrelationships between input parameters 302 and output parameters 306 (step 408). In certain embodiments, virtual sensor process model 304 may correspond to a computational model, such as, for example, a computational model built on any appropriate type of neural network.

The type of neural network computational model that may be used may include any appropriate type of neural network model. For example, a feed forward neural network model may be included to establish virtual sensor process model 304. Other types of neural network models, such as back propagation, cascaded neural networks, and/or hybrid neural networks, etc., may also be used. Particular types or structures of the neural network used may depend on particular applications. Although neural network models are illustrated, other types of computational models, such as linear system or non-linear system models, etc., may also be used.

The neural network computational model (i.e., virtual sensor process model 304) may be trained by using selected data records. For example, the neural network computational model may include a relationship between output parameters 306 (e.g., NOₓ emission level, soot emission level, and/or HC emission level, etc.) and input parameters 302 (e.g., fuel rate, injection timing, intake manifold pressure, intake manifold temperature, IVA end of current, injection pressure, and engine speed, etc.). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), processor 202 may statistically validate the computational model (step 410). Statistical validation may refer to an analyzing process to compare outputs of the neural network computational model with actual or expected outputs to determine the accuracy of the computational model. Part of the data records may be reserved for use in the validation process.

Alternatively, processor 202 may also generate simulation or validation data for use in the validation process. This may be performed either independently of a validation sample or in conjunction with the sample. Statistical distributions of inputs may be determined from the data records used for modeling. A statistical simulation, such as Latin Hypercube simulation, may be used to generate hypothetical input data records. These input data records are processed by the computational model, resulting in one or more distributions of output characteristics. The distributions of the output characteristics from the computational model may be compared to distributions of output characteristics observed in a population. Statistical quality tests may be performed on the output distributions of the computational model and the observed output distributions to ensure model integrity.

Once trained and validated, virtual sensor process model 304 may be used to predict values of output parameters 306 when provided with values of input parameters 302. Further, processor 202 may utilize virtual sensor process model 304 to generate desired distributions of input parameters 302 based on relationships between input parameters 302 and desired distributions of output parameters 306 (step 412). The resulting desired input characteristics may be provided to ECM 120 to be analyzed to improve operation of engine system 102.

Processor 202 may analyze the relationships between desired distributions of input parameters 302 and desired distributions of output parameters 306 based on particular applications. For example, processor 202 may select desired ranges for output parameters 306 (e.g., NOₓ emission level, soot emission level, or HC emission level that is desired or within certain predetermined range). Processor 202 may then run a simulation of the computational model to find a desired statistic distribution for an individual input parameter (e.g., one of fuel rate, injection timing, intake manifold pressure, intake manifold temperature, IVA end of current, injection pressure, engine speed, and certain delayed parameters, etc.). That is, processor 202 may separately determine a distribution (e.g., mean, standard variation, etc.) of the individual input parameter corresponding to the normal ranges of output parameters 306. After determining respective distributions for all individual input parameters, processor 202 may combine the desired distributions for all the individual input parameters to determine desired distributions and characteristics for overall input parameters 302.

Alternatively, processor 202 may identify desired distributions of input parameters 302 simultaneously to maximize the possibility of obtaining desired outcomes. In certain embodiments, processor 202 may simultaneously determine desired distributions of input parameters 302 based on zeta statistic. Zeta statistic may indicate a relationship between input parameters, their value ranges, and desired outcomes. Zeta statistic may be represented as

$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$

where x̅ᵢ represents the mean or expected value of an ith input; x̅ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, x̅ᵢ may be less than or equal to zero. A value of 3σᵢ may be added to x̅ᵢ to correct such problematic condition. If, however, x̅ᵢ is still equal zero even after adding the value of 3σᵢ, processor 202 may determine that σᵢ may be also zero and that the process model under optimization may be undesired. In certain embodiments, processor 202 may set a minimum threshold for σᵢ to ensure reliability of process models. Under certain other circumstances, σⱼ may be equal to zero. Processor 202 may then determine that the model under optimization may be insufficient to reflect output parameters within a certain range of uncertainty. Processor 202 may assign an indefinite large number to ζ.

Processor 202 may identify a desired distribution of input parameters 302 such that the zeta statistic of the neural network computational model (i.e., virtual sensor process model 304) is maximized or optimized. An appropriate type of genetic algorithm may be used by processor 202 to search the desired distribution of input parameters 302 with the purpose of maximizing the zeta statistic. Processor 202 may select a candidate set of values of input parameters 302 with predetermined search ranges and run a simulation of virtual sensor process model 304 to calculate the zeta statistic parameters based on input parameters 302, output parameters 306, and the neural network computational model (e.g., virtual sensor process model 304). Processor 202 may obtain x̅ᵢ and σᵢ by analyzing the candidate set of values of input parameters 302, and obtain x̅ⱼ and σⱼ by analyzing the outcomes of the simulation. Further, processor 202 may obtain |Sᵢⱼ| from the trained neural network as an indication of the impact of the ith input on the jth outcome.

Processor 202 may select the candidate set of values of input parameters 302 if the genetic algorithm converges (i.e., the genetic algorithm finds the maximized or optimized zeta statistic of virtual sensor process model 304 corresponding to the candidate set values of input parameters 302). If the genetic algorithm does not converge, a different candidate set of values of input parameters 302 may be created by the genetic algorithm for further searching. This searching process may continue until the genetic algorithm converges and a desired set of values of input parameters 302 is identified. Processor 202 may further determine desired distributions (e.g., mean and standard deviations) of input parameters 302 based on the desired set of values of input parameters 302. Once the desired distributions are determined, processor 202 may define a valid input space that may include any input parameter within the desired distributions (step 414).

In one embodiment, statistical distributions of certain input parameters may be impossible or impractical to control. For example, an input parameter may be associated with a physical attribute of a device, such as a dimensional attribute of an engine part, or the input parameter may be associated with a constant variable within virtual sensor process model 304 itself. These input parameters may be used in the zeta statistic calculations to search or identify desired distributions for other input parameters corresponding to constant values and/or statistical distributions of these input parameters.

Further, optionally, more than one virtual sensor process model may be established. Multiple established virtual sensor process models may be simulated by using any appropriate type of simulation method, such as statistical simulation. For example, around 150 models may be simulated. Output parameters 306 based on simulation of these multiple virtual sensor process models may be compared to select a most-fit virtual sensor process model or several most-fit virtual sensor process models based on predetermined criteria, such as smallest variance with outputs from corresponding physical sensors, etc. The selected most-fit virtual sensor process model 304 may be deployed in virtual sensor applications and engine control applications. Alternatively, more than one virtual sensor process models may be interconnected to form a network of virtual sensor process models or virtual sensors.

After virtual sensor process model 304 is trained, validated, optimized, and/or selected, virtual sensor 300 may be ready to be used by ECM 120 to provide relevant control functions. Additionally, processor 202 may further analyze data records used to train, validate, and/or optimize virtual sensor process model 304 to generate calibration data of virtual sensor process model 304. Calibration data, as used herein, may refer to any characteristic data associated with training, validating, and/or optimizing virtual sensor process model 304. For example, calibration data may include statistical distributions of input parameters 302 and/or output parameters 306, ranges of input parameters 302 and output parameters 306, etc., or any data used and/or associated with the processes of training, validating, and optimizing virtual sensor process model 304, such as mahalanobis distance of each data records of input parameters 302. Further, processor 202 may store the calibration data as data associated with virtual sensor 300.

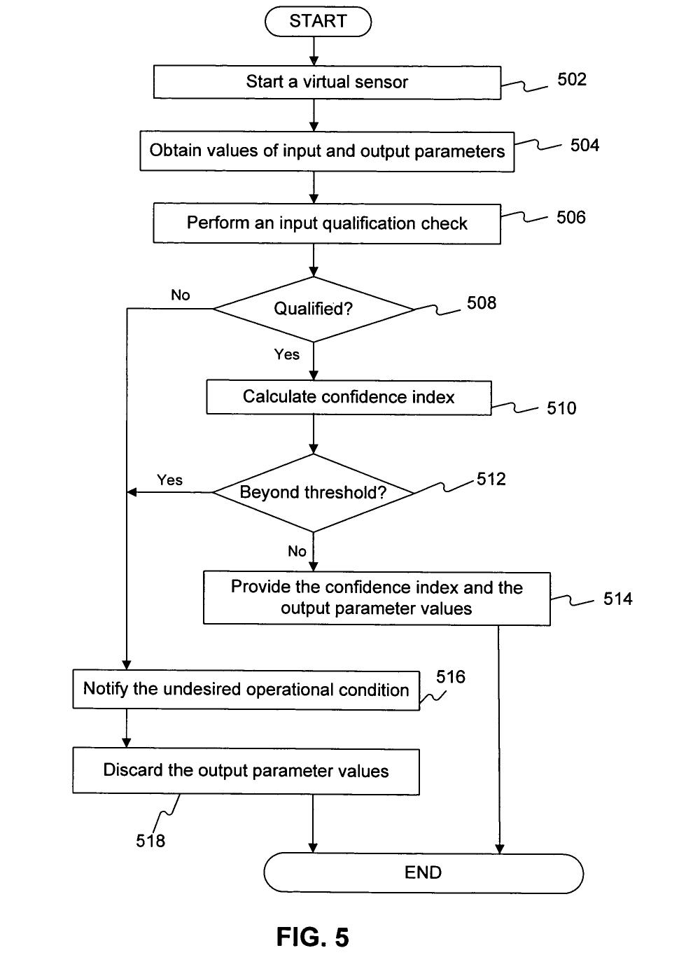

Processor 202 may use virtual sensor process model 304 to provide control functions to any relevant components of vehicle 100. For example, virtual sensor process model 304 may calculate or predict NOₓ emission level, soot emission level, and/or HC emission level to ECM 120 and ECM 120 may control engine 110 according to the regulated emission levels provided by virtual sensor 300, and, in particular, by virtual sensor process model 304. FIG. 5 shows an exemplary operation process performed by processor 202.

As shown in FIG. 5, processor 202 may start virtual sensor 300 (step 502). Processor 202 may start virtual sensor 300 by load and/or execute computer programs representing virtual sensor processor model 304. Processor 202 may also load or retrieve data associated with virtual sensor process model 304, such as calibration data of virtual sensor process model 304. Further, processor 202 may obtain values of input and output parameters (step 504). Processor 202 may obtain a set of specific values of input parameters 302 based on measurement of input parameters 302 (e.g., measured parameters, such as intake manifold temperature, intake manifold pressure, ambient humidity, fuel rates, and engine speeds, etc.). Processor 202 may provide the obtained set of values of input parameters 302 to virtual sensor process model 304, which may generate corresponding values of the output parameters 306. Processor 202 may also retrieve the corresponding values of output parameters 306 from virtual sensor process model 304 after the values of output parameters 306 are generated.

As explained above, the values of output parameters 306 may be used by processor 202 or ECM 120 for providing control functions to engine system 102. However, before using the values of output parameters 306 to control engine system 102, processor 202 may estimate an operational accuracy of virtual sensor process model 304. An operational accuracy, as used herein, may reflect a likelihood of virtual sensor process model providing accurate output parameter values. Processor 202 may determine the accuracy of virtual sensor process model 304 based upon various factors, such as the accuracy of the underlying mathematical model, the adequateness of training, validating, and/or optimizing virtual sensor process model 304, and/or the characteristics of input parameters 302, etc. Other factors, however, may also be used.

In certain embodiments, processor 202 may perform an input qualification check on the values of input parameters 302 to determine the operational accuracy of virtual sensor process model 304 (step 506). That is, processor 202 may check the values of input parameters 302 to determine whether the values of input parameters 302 are qualified as valid input values such that the corresponding values of output parameters 306 may be deemed as valid and the operation of virtual sensor process model 304 may be deemed as accurate. Further, processor 202 may perform the input qualification check based on the calibration data. For example, processor 202 may obtain a range of each input parameters from the calibration data and may compare the specific values of input parameters with the respective ranges of input parameters 302. The range of an input parameter may reflect an operation scope within which virtual sensor process model 304 has been trained, validated, and/or optimized.

Processor 202 may determine whether specific values of input parameters 302 are qualified input values (step 508). Processor 202 may determine the qualification of a specific value of an input parameter based on the comparison between the specific value and the range of the input parameter. For example, processor 302 may determine that a specific value of an input parameter is not a qualified input value if the specific value is not within the range of the input parameter. Processor 202 may also determine that the specific value is a qualified input value if the specific value is within the range of the input parameter. Other criteria for determining qualified input values may also be used.

Processor 202 may determine the qualifications for each input parameter individually, and may determine that the specific values of input parameters 302 are not qualified if a value of one of input parameters 302 is not a qualified value. Alternatively, processor 202 may set up a threshold number of individual input parameters. If more than the threshold number of input parameters 302 have unqualified values, the set of specific values of input parameters 302 may be determined as unqualified input values.

If processor 302 determines that the values of input parameters 302 are not qualified input values (step 508; no), processor 202 may determine that the operational accuracy of virtual sensor process model 304 is low and the operation condition (e.g., the values of input parameters 302 provided to virtual sensor process model 304) is undesired. Processor 302 may notify the undesired operation condition of unqualified input values to ECM 120 or other control systems (step 516). Optionally, processor 302 may also discard corresponding values of output parameters 306 (step 518). Processor 302 may use a previous set of values of output parameters 306 corresponding to the latest qualified values of input parameters 302 to control engine system 102.

On the other hand, if processor 302 determines that the values of input parameters 302 are qualified input values (step 508; yes), processor 302 may further or optionally calculate a confidence index of input parameters 302 (step 510).

Processor 202 may calculate a confidence index based on the specific values of input parameters 302 and the calibration data. A confidence index, as used herein, may reflect qualification of a combination of a part or all of input parameters 302. That is, the likelihood for virtual sensor process model 304 to provide accurate output parameter values when provided with a specific combination of the values of input parameters 302. Under certain circumstances, even if values of input parameters 302 may be qualified individually, a combination of the values of part or all of input parameters 302, i.e., a specific data pattern of input parameters 302, may be unqualified and thus may result in low operational accuracy of virtual sensor process model 304. Because data patterns of input parameters 302 may be recorded when training, validating, and/or optimizing virtual sensor process model 304 as part of the calibration data, the calibration data may be used to define a valid scope or range of data patterns of input parameters 302 measured by the confidence index.

Processor 202 may calculate the confidence index using various criteria and algorithms. For example, processor 202 may calculate the confidence index based on the mahalanobis distance as previously explained. Processor 202 may calculate a mahalanobis distance of the specific data pattern, or the set of values of input parameters 302, according to equation (1) and based on the calibration data indicative valid data patterns of input parameters 302. Such mahalanobis distance may reflect a variance of a set of specific values of input parameters 302 with respect to valid scope of data patterns of input parameters 302. A large variance may correspond to a low operational accuracy.

Processor 202 may derive the confidence index based on the mahalanobis distance. For example, processor 202 may use the mahalanobis distance as the confidence index directly, or processor 202 may derive the confidence index as the mahalanobis distance adjusted by an integer number (e.g., 1, 2, etc.). Other adjustment methods, however, may also be used.

After calculating the confidence index (step 510), processor 202 may determine whether the confidence index is beyond a predetermined threshold (step 512). If processor 202 determines that the confidence index exceeds the predetermined threshold (step 512; yes), processor 202 may determine that the variance of the specific values of input parameters is large and the operational accuracy of virtual sensor process model 304 may be low and the operation condition of virtual sensor process model 304 may be undesired. Processor 202 may obtain the predetermined threshold from a user of vehicle 100 or may determine the threshold based on the calibration data, e.g., statistical distribution of mahalanobis distance of input parameters 302, etc.

Processor 202 may notify the undesired operation condition of unqualified input values to ECM 120 or other control system (step 516). Optionally, processor 302 may also discard corresponding values of output parameters 306 (step 518). In certain embodiments, the discarded output parameter values may be used to create values of certain indication parameters indicating the degree to which current values of input parameters 302 are out of corresponding ranges. For example, the indication parameters may also include values representing a MD distance value greater than a allowable threshold. Other indication parameters, however, may also be used. These indication parameters may be provided to ECM 120 to indicate that virtual sensor process model 304 may be unqualified for accurate operation under the range defined by the values of input parameters 302 and output parameters 306. Processor 202 may use a previous set of values of output parameters 306 corresponding to the latest qualified values of input parameters 302 to control engine system 102, and may continue until the values of input parameters 302 are within a qualified range.

On the other hand, if processor 202 determines that the confidence index is not beyond the predetermined threshold (step 512; no), processor 202 may provide corresponding values of output parameters 306 to control engine system 102 (step 514). Processor 202 may also provide the confidence index to the ECM 120 or other control system for further analysis.

Alternatively, processor 202 may check the input qualification of the set of values of input parameters 302 and/or calculate the confidence index before providing the set of values of input parameters 302 to virtual sensor process model 304 to generate values of output parameters 306. If processor 202 determines that the set of values are not qualified input values or the confidence index is beyond a predetermined threshold, processor 202 may discard the set of values of input parameters 302 without further providing the set of values of input parameters 302 to virtual sensor process model 304 for generating the values of output parameters 306. On the other hand, if processor 202 determines that the set of values are qualified input values and/or the confidence index is not beyond the predetermined threshold, processor 202 may provide the set of values of input parameters 302 to virtual sensor process model 304 to generate the values of output parameters 306 and to control engine system 102 based on the values of output parameters 306.

Further, also alternatively, the confidence index may be used during the processes of training, validating, and/or optimizing virtual sensor process model 304. For example, the confidence index may be included in output parameters 306 such that the operational accuracy of virtual sensor process model 304 may be included in the process of establishing virtual sensor process model 304. When optimizing virtual sensor process model 304, a desired operation accuracy range may be introduced to derive an input space for input parameters 302 such that the desired operation accuracy may be achieved.

### INDUSTRIAL APPLICABILITY

The disclosed systems and methods may provide efficient and accurate solutions for verifying virtual sensor systems and, more particularly, for real-time verification of operational accuracy of the virtual sensor systems. Because virtual sensor systems may be used in broad ranges of applications, verification of accurate operation conditions for the virtual sensor systems is critical to many applications. For example, real-time operational accuracy verification of virtual sensors may significantly reduce the likelihood of generating erroneous or inaccurate output parameter values that may be caused by out of range input parameter values or undesired data patterns of the input parameters. The undesired output parameters values corresponding to such input parameter values or patterns may be filtered out automatically. Therefore, such verification systems and methods may provide desired solutions for removing or reducing interference and other disturbing factors causing unqualified input parameter values and may also increase the stability of control system using the virtual sensor systems.

The disclosed systems and methods may also provide a general solution to any application utilizing process models, such as control systems, financial analysis tools, and medical analysis tools, etc., to filter out undesired operational conditions in order to increase error tolerance of the application and the process models. Manufacturers and developers of such applications may incorporate the disclosed systems and methods into the applications, or may embed the principles of the disclosed systems and methods into the applications and the process models to provide real-time operation accuracy verification capability.

Other embodiments, features, aspects, and principles of the disclosed exemplary systems will be apparent to those skilled in the art and may be implemented in various environments and systems.

What is claimed is:

1. A method for a virtual sensor system, comprising:
starting at least one established virtual sensor process model indicative of interrelationships between a plurality of input parameters and a plurality of output parameters;
retrieving calibration data associated with the virtual sensor process model;
obtaining a set of values of the plurality of input parameters;
calculating corresponding values of the plurality of output parameters simultaneously based upon the set of values of the plurality of input parameters and the virtual sensor process model; and
determining whether the set of values of input parameters are qualified for the virtual sensor process model to generate the values of the plurality of output parameters with desired accuracy based on the calibration data.

2. The method according to claim 1, wherein determining further includes:
obtaining respective ranges of the plurality of input parameters based on the calibration data;
determining whether the value of at least one of the input parameters is within the obtained range of the at least one of the input parameters; and
determining that the set of values of input parameters are not qualified if the value of the at least one of the input parameters is not within the obtained range.

3. The method according to claim 1, wherein determining further includes:
calculating a confidence index of the set of values of the plurality of input parameters based on the calibration data;
comparing the confidence index with a predetermined threshold; and
determining that the set of values of the input parameters are not qualified if the confidence index is beyond the predetermined threshold.

4. The method according to claim 3, wherein calculating further includes:
calculating a mahalanobis distance of the set of values of the input parameters based on the calibration data; and
deriving the confidence index from the mahalanobis distance.

5. The method according to claim 3, further including:
if the confidence index is not beyond the predetermined threshold, providing the values of the output parameters and the confidence index to a control system.

6. The method according to claim 1, further including:
if it is determined that the set of values of input parameters are not qualified, notifying an undesired operational condition to a control system; and
discarding the values of output parameters.

7. The method according to claim 6, further including:
calculating at least one indication parameter corresponding to a degree to which the set of values of input parameters are not qualified based on the values of output parameters; and
indicating that the virtual sensor process model 304 is unqualified when provided with the set of values of input parameters and the output parameters based on the indication parameter.

8. The method according to claim 7, further including:
continuing using a last qualified set of values of the input parameters until it is determined that a new set of values of the input parameters are qualified.

9. The method according to claim 1, wherein the plurality of input parameters include one or more of engine speed, fuel rate, injection timing, intake manifold temperature, intake manifold pressure, inlet valve actuation end of current, and injection pressure.

10. The method according to claim 1, wherein the plurality of output parameters include one or more of NOₓ emission level, soot emission level, HC emission level, soot oxidation rate, soot passive regeneration rate, exhaust manifold temperature, air system pressure and temperature estimations, gas-to-brick temperature offset estimation, auxiliary regeneration flame detection temperature, sound emission levels, heat rejection levels, and vibration levels.

11. The method according to claim 1, wherein the process model is established by:
obtaining data records associated with one or more input variables and the plurality of output parameters;
selecting the plurality of input parameters from the one or more input variables;
generating a computational model indicative of the interrelationships between the plurality of input parameters and the plurality of output parameters;
determining desired statistical distributions of the plurality of input parameters of the computational model;
defining a desired input space based on the desired statistical distributions; and
storing data used and created during the establishment of the process model as the calibration data associated with the process model.

12. The method according to claim 11, wherein selecting further includes:
pre-processing the data records; and
using a genetic algorithm to select the plurality of input parameters from the one or more input variables based on a mahalanobis distance between a normal data set and an abnormal data set of the data records.

13. The method according to claim 11, wherein generating further includes:
creating a neural network computational model;
training the neural network computational model using the data records; and
validating the neural network computation model using the data records.

14. The method according to claim 11, wherein determining further includes:
determining a candidate set of values the input parameters with a maximum zeta statistic using a genetic algorithm; and
determining the desired distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

15. The method according to claim 1, wherein the at least one established virtual sensor process model includes a network of virtual sensor process models with interrelated relationships.

15. A system for a virtual sensor process model, comprising:
a database configured to store information relevant to the virtual sensor process model and calibration data associated with the virtual sensor process model; and
a processor configured to:
start the virtual sensor process model indicative of interrelationships between a plurality of input parameters and a plurality of output parameters;
retrieve calibration data associated with the virtual sensor process model;
obtain a set of values of the plurality of input parameters;
calculate corresponding values of the plurality of output parameters simultaneously based upon the set of values of the plurality of input parameters and the virtual sensor process model; and
determine whether the set of values of input parameters are qualified for the virtual sensor process model to generate the values of the plurality of output parameters with desired accuracy based on the calibration data.

17. The system according to claim 16, wherein, to determine whether the set of values of input parameters are qualified, the processor is further configured to:
obtain respective ranges of the plurality of input parameters based on the calibration data;
determine whether the value of at least one of the input parameters is within the obtained range of the at least one of the input parameters; and
determine that the set of values of input parameters are not qualified if the value of the at least one of the input parameters is not within the obtained range.

18. The system according to claim 16, wherein, to determine whether the set of values of input parameters are qualified, the processor is further configured to:
calculate a confidence index of the set of values of the plurality of input parameters based on the calibration data;
compare the confidence index with a predetermined threshold; and
determine that the set of values of the input parameters are not qualified if the confidence index is beyond the predetermined threshold.

19. The system according to claim 18, wherein, to calculate the confidence index, the processor is further configured to:
calculate a mahalanobis distance of the set of values of the input parameters based on the calibration data; and
derive the confidence index from the mahalanobis distance.

20. The system according to claim 18, wherein the processor is further configured to:
provide the values of the output parameters and the confidence index to a control system, if the confidence index is not beyond the predetermined threshold.

21. The system according to claim 16, wherein the processor is further configured to:
notify an undesired operational condition to a control system, if it is determined that the set of values of input parameters are not qualified;
discard the values of output parameters;
calculate at least one indication parameter corresponding to a degree to which the set of values of input parameters are not qualified based on the values of output parameters; and
indicate that the virtual sensor process model 304 is unqualified when provided with the set of values of input parameters and the output parameters based on the indication parameter.

22. A computer-readable medium for use on a computer system configured to establish at least one virtual sensor process model, the computer-readable medium having computer-executable instructions for performing a method comprising:
obtaining data records associated with one or more input variables and a plurality of output parameters;
selecting the plurality of input parameters from the one or more input variables;
generating a computational model indicative of the interrelationships between the plurality of input parameters and the plurality of output parameters;
determining desired statistical distributions of the plurality of input parameters of the computational model;
defining a desired input space based on the desired statistical distributions; and
storing data used and created during the establishment of the process model as the calibration data associated with the process model.

23. The computer-readable medium according to claim 22, wherein the at least one virtual sensor process model includes a network of virtual sensor process models with interrelated relationships.

24. The computer-readable medium according to claim 22, wherein the selecting further includes:
pre-processing the data records; and
using a genetic algorithm to select the plurality of input parameters from the one or more input variables based on a mahalanobis distance between a normal data set and an abnormal data set of the data records.

25. The computer-readable medium according to claim 22, wherein generating further includes:
creating a neural network computational model;
training the neural network computational model using the data records; and
validating the neural network computation model using the data records.

26. The computer-readable medium according to claim 22, wherein determining further includes:
determining a candidate set of values the input parameters with a maximum zeta statistic using a genetic algorithm; and
determining the desired distributions of the input parameters based on the candidate set,
wherein the zeta statistic ζ is represented by:
$$ζ = {\sum }_{1}^{j} {\sum }_{1}^{i} \vert {S}_{ij} \vert ( \frac{{σ}_{i}}{{\overline{x}}_{i}} ) ( \frac{{\overline{x}}_{j}}{{σ}_{j}} ) ,$$
provided that x̅ᵢ represents a mean of an ith input; x̅ⱼ represents a mean of a jth output; σᵢ represents a standard deviation of the ith input; σⱼ represents a standard deviation of the jth output; and |Sᵢⱼ| represents sensitivity of the jth output to the ith input of the computational model.
